(19) United States
(12) Patent Application Publication
(10) Pub. No.: US 2009/0058808 A1
(43) Pub. Date: Mar. 5, 2009

(54) Computer mouse device

(75) Inventors: Chin-Hao Hung, Sijhih City (TW); Tien-Hao Yang, Sijhih City (TW)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: BEHAVIOR TECH COMPUTER CORP.

(21) Appl. No.: 12/009,491

(22) Filed: Jan. 18, 2008

(30) Foreign Application Priority Data
Aug. 30, 2007 (TW) 96214502

(51) Int. Cl. G06F 3/033

(52) U.S. Cl. 345/163

(57) ABSTRACT

A mouse device includes a main body and a cover. The main body includes a roller wheel, a left key and a right key, wherein the roller wheel is sandwiched between the left key and the right key. The cover includes a right key cover and a left key cover to define an opening between thereof, wherein the right key cover and the left key cover are separately pivotally connected to the main body. When the cover lies against a top surface of the main body, the right key cover lies against the right key, the left key cover lies against the left key, and the opening exposes the roller wheel.

### RELATED APPLICATIONS

This application claims priority to Taiwan Application Serial Number 96214502, filed Aug. 30, 2007, which is herein incorporated by reference.

### BACKGROUND

1. Field of Invention

The present invention relates to a computer mouse device.

2. Description of Related Art

As Internet instant communication advances rapidly and some excellent software (such as Skype) has been developed, more and more users would choose these communication interfaces as their communication tool. Therefore, more efforts should be focused on improving Human Machine Interface, i.e. computer mouse, such that users are able to operate these communication interfaces conveniently.

### SUMMARY

It is therefore an objective of the present invention to provide a computer mouse device.

In accordance with the foregoing and other objectives of the present invention, a mouse device includes a main body and a cover. The main body includes a roller wheel, a left key and a right key, wherein the roller wheel is sandwiched between the left key and the right key. The cover includes a right key cover and a left key cover to define an opening between thereof, wherein the right key cover and the left key cover are separately pivotally connected to the main body. When the cover lies against a top surface of the main body, the right key cover lies against the right key, the left key cover lies against the left key, and the opening exposes the roller wheel.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a mouse device as described in an embodiment herein; and

FIG. 2 illustrates a mouse device as described in another embodiment herein.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

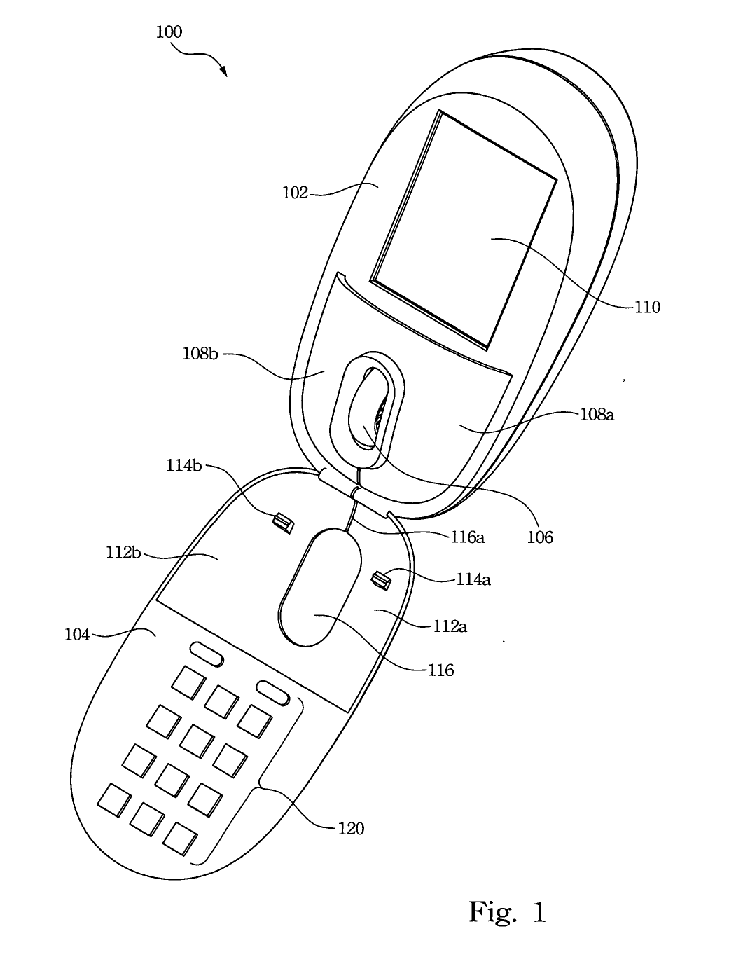

FIG. 1 illustrates a mouse device as described in an embodiment herein. The mouse device 100 includes a main body 102 and a cover 104. Because of adding the cover 104, more components, i.e. buttons and screen, may be integrated on the cover 104 or the main body 102. The main body 102 has a left key 108a, a right key 108b and a roller wheel 106. The roller wheel 106 is sandwiched between the left key 108a and right key 108b. The cover 104 has a left key cover 112a and a right key cover 112b. An opening 116 is defined between the left key cover 112a and the right key cover 112b. A gap 116a, which extends from the opening 116, separates the left key cover 112a and the right key cover 112b. The left key cover 112a and the right key cover 112b are respectively pivotally connected with the main body 102 such that the cover 104 may be lay against the main body 102 or away from the 102 (as illustrated in FIG. 1). When the cover 104 lies against the main body 102, the left key cover 112a lies against the left key 108a, the right key cover 112b lies against the right key 108b and the opening 116 exposes the roller wheel 106. Therefore, whether the cover 104 lies against the main body 102 or not, the left key 108a, the right key 108b and the roller wheel 106 can be operated by users. When the cover 104 lies against the main body 102, users press the left key cover 112a to force down the left key 108a or press the right key cover 112b to force down the right key 108a. The cover 104 may has a pair of convex members 114a/114b respectively located on a surface of the right key cover 112b and a surface of the left key cover 112a, which both are lay against the main body 102. When the cover 104 lies against a top surface of the main body 102, the convex members 114a/114b are respectively sandwiched between the right key 108b and the right key cover 112b, the left key 108a and the left key cover 112a for effectively forcing down the left key 108a or the right key 108b. Besides, the main body 102 may have a display screen 110, and the cover 104 may have a button area 120. The display screen 110 can be designed on a bottom wall of a concave area, which is able to accommodate the button area 120 (when the cover 104 lies against the main body 102). The display screen 110 can be a liquid crystal display, organic light emitting diode display or electrical paper display. A circuit board may be designed under the button area 120. When any button of the button area 120 is pressed, the circuit board receives the press action and sends a signal to the main body 102. When the button area 120 is right above the display screen 110 when the cover 104 lies against the top surface of the main body 102. By using the button area 120, users can input phone numbers or control information to operate a connected computer. The display screen 110 can display what is input or any other information.

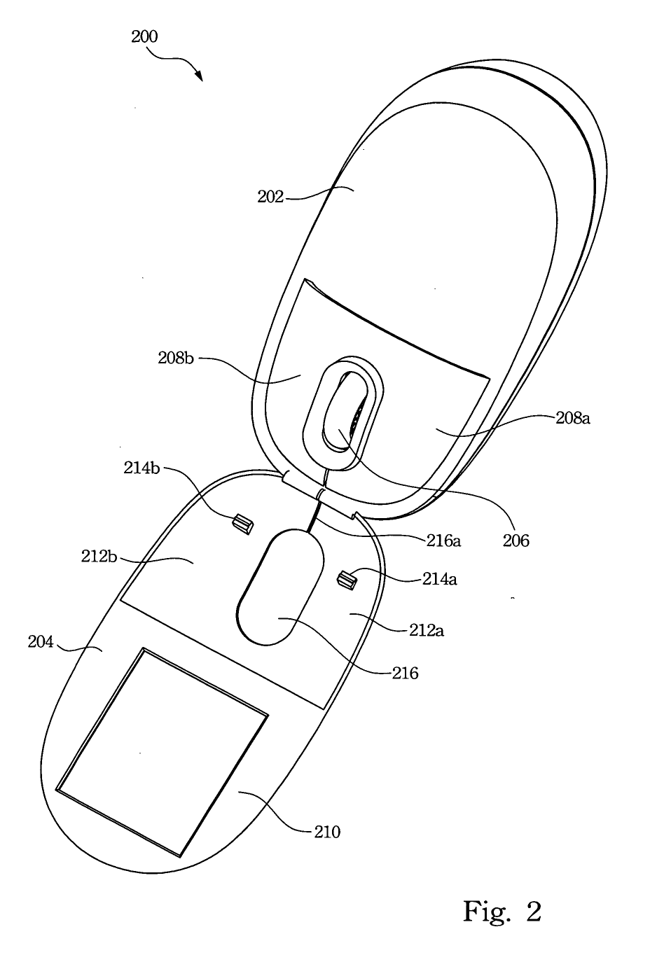

FIG. 2 illustrates a mouse device as described in another embodiment herein. The mouse device 200 includes a main body 202 and a cover 204. Because of adding the cover 204, more components, i.e. buttons and screen, may be integrated on the cover 204 or the main body 202. The main body 202 has a left key 208a, a right key 208b and a roller wheel 206. The roller wheel 206 is sandwiched between the left key 208a and right key 208b. The cover 204 has a left key cover 212a and a right key cover 212b. An opening 216 is defined between the left key cover 212a and the right key cover 212b. A gap 216a, which extends from the opening 216, separates the left key cover 212a and the right key cover 212b. The left key cover 212a and the right key cover 212b are respectively pivotally connected with the main body 202 such that the cover 204 may be lay against the main body 202 or away from the 202 (as illustrated in FIG. 2). When the cover 204 lies against the main body 202, the left key cover 212a lies against the left key 208a, the right key cover 212b lies against the right key 208b and the opening 216 exposes the roller wheel 206. Therefore, whether the cover 204 lies against the main body 202 or not, the left key 208a, the right key 208b and the roller wheel 206 can be operated by users. When the cover 204 lies against the main body 202, users press the left key cover 212a to force down the left key 208a or press the right key cover 212b to force down the right key 208a. The cover 204 may has a pair of convex members 214a/214b respectively located on a surface of the right key cover 212b and a surface of the left key cover 212a, which both are lay against the main body 202. When the cover 204 lies against a top surface of the main body 202, the convex members 214b/214a are respectively sandwiched between the right key 208b and the right key cover 212b, the left key 208a and the left key cover 212a for effectively forcing down the left key 208a or the right key 208b. Besides, the cover 204 may have a display screen 210 to display information. The display screen 210 can be a liquid crystal display, organic light emitting diode display or electrical paper display. The display screen 210 may also be touch control screen. By using the touch control screen, users can input phone numbers or control information to operate a connected computer. The display screen 210 can also display what is input or any other information.

According to embodiments discussed above, the mouse device as described herein is equipped with a cover such that more components can be integrated on the mouse device for conveniently operating a connected computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mouse device, comprising:
a main body, comprising a roller wheel, a left key and a right key, wherein the roller wheel is sandwiched between the left key and the right key; and
a cover, comprising a right key cover and a left key cover to define an opening between thereof, wherein the right key cover and the left key cover are separately pivotally connected the main body,
when the cover lies against a top surface of the main body, the right key cover lies against the right key, the left key cover lies against the left key, and the opening exposes the roller wheel.

2. The mouse device of claim 1, wherein the cover comprises a bottom area on a surface, which is lay against the main body.

3. The mouse device of claim 1, wherein the cover comprises a display screen on a surface, which is lay against the main body.

4. The mouse device of claim 3, wherein the display screen is a touch control screen.

5. The mouse device of claim 2, wherein the body comprises a display screen, and the button area is right above the display screen when the cover lies against the top surface of the main body.

6. The mouse device of claim 5, wherein the display screen is a liquid crystal display, organic light emitting diode or electrical paper display.

7. The mouse device of claim 6, wherein the display screen is disposed on a bottom area of a concave area of the main body.

8. The mouse device of claim 1, wherein the cover comprises a pair of convex members respectively located on a surface of the right key cover and a surface of the left key cover, which both are lay against the main body.

9. The mouse device of claim 8, wherein the pair of convex members are respectively sandwiched between the right key and the right key cover, the left key and the left key cover when the cover lies against a top surface of the main body.
